(19) United States
(12) Patent Application Publication
(10) Pub. No.: US 2022/0270464 A1
(43) Pub. Date: Aug. 25, 2022

(54) HEALTHY INDOOR ENVIRONMENT AND AIR QUALITY MONITORING SYSTEM AND METHOD FOR ACCESSING AND SHARING INFORMATION, PUBLICLY

(71) Applicant: VizAeras Inc., Costa Mesa, CA (US)

(72) Inventors: Carl Henly TAUTENHAHN, Costa Mesa, CA (US); Kevin David MALONEY, Costa Mesa, CA (US); Gerald Monroe TAUTENHAHN, Costa Mesa, CA (US)

(21) Appl. No.: 17/677,564

(22) Filed: Feb. 22, 2022

Related U.S. Application Data
(60) Provisional application No. 63/152,046, filed on Feb. 22, 2021.

(51) Int. Cl. G08B 21/12; G08B 17/10; G06K 9/00; G06K 7/14

(52) U.S. Cl. CPC G08B 21/12; G08B 17/10; G06K 9/00503; G06K 7/1417

(57) ABSTRACT

Disclosed embodiments may include an air quality measuring system for determining the environmental risk of indoor pollutants to occupants. The system may include sensors for monitoring a number of airborne pollutants and pathogens. The system may allow a user to interact with the system by scanning a QR code. The system may display, on a user's mobile device, the amount of airborne pollutants in an indoor space. The system may allow the user to share the system's readings by a link, social media post, or public ratings website. The system may be capable of interacting with building smart systems, fire alarms, and HVAC systems. The system may also be capable of sounding an alarm if air quality thresholds are outside a normal range.

### CROSS REFERENCE TO RELATED APPLICATIONS

This application claims priority under 35 U.S.C. § 119 to U.S. Provisional Patent Application No. 63/152,046, filed Feb. 22, 2021, the entire contents of which are fully incorporated herein by reference.

### FIELD

The present disclosure relates to monitoring and providing access to critical indoor environmental health and safety data.

### BACKGROUND

Indoor air pollution poses a serious health risk to populations worldwide. Americans, for example, spend approximately 90% of their time indoors at work, home, or school—where indoor pollutants are often 2 to 5 times higher than typical outdoor concentrations. The U.S. EPA ranks indoor pollution as a top five environmental risk to public health and estimates that poor indoor air quality affects 33% to 50% of commercial buildings in the U.S. and is responsible for over 10 million lost work days per year. Globally, approximately 3.8 million people die every year as a result of indoor air pollution.

One common medical condition made worse by poor indoor air quality is chronic obstructive pulmonary disease (COPD), which has grown to be a serious health problem and a cause of large numbers of avoidable deaths, annually. Poor indoor air quality can also trigger symptoms in asthmatics, which afflicts a growing number of people worldwide and which is made worse with the recent pandemic of COVID-19. Between 2019 and 2020, COVID-19 has confirmed the urgent need to monitor and track indoor environmental quality (IEQ) conditions and provide transparency and access to the critical factors that affect healthy building metrics for the most valuable asset inside the building, its occupants. According to a May 2020 Cohesion survey, commercial office building tenants and employees want to feel confident that their buildings are safe and clean, with building cleanliness and Indoor Air and Environmental Quality (IAQ) decidedly the most important factors.

Carbon dioxide monitoring (CO2) is also becoming an imperative part of COVID-19 preparedness and planning. In California, for example, Governor Newsom signed California Assembly Bill AB 841 into law in September 2020, mandating indoor air quality monitoring to reduce COVID-19 transmission and infection risk. The bill requires classrooms to monitor CO2 and provide an alert when the carbon dioxide levels in the classroom have exceeded 1,100 ppm. When people exhale inside a room, carbon dioxide aerosols containing pathogens such as SARS-CoV-2 (COVID-19) from infected individuals can be used as a vehicle to increase virus concentrations in the indoor air, as shown by the University of Colorado and Harvard School of Public Health. Is it important we monitor indoor CO2 levels inside our homes, offices and classrooms, and retail businesses such as restaurants, malls, and movie theaters (targeting concentrations below 1,100 PPM) and provide access to this information so that high concentrations can be addressed or remedied with proper ventilation and airflow. A non-exhaustive list of common indoor air pollutants of particular concern, as they can lead to major health conditions and poor productivity, include combustion byproducts such as carbon dioxide (CO2), carbon monoxide (CO), nitrogen oxides (NO), particulate matter (PM), and tobacco smoke; biological agents such as molds, viruses, and bacteria; volatile organic compounds (VOCs) released from indoor furnishings and building materials, chemical fumes from paints, solvents, and cleaning products; substances of natural origin such as radon, outdoor smoke, animal hair and pet dander, and dust mites; and others such as ozone, pesticides, lead, and asbestos. Some known symptoms of indoor air pollution include worsening asthma, allergies, and other respiratory problems, headaches and nausea, shortness of breath, sinus congestions, sneezing and cough, eye, skin, nose and throat irritations, memory loss, dizziness, fatigue, lack of concentration or ability to focus, and depression.

Numerous studies have shown an association between indoor air quality and heart disease. In particular, carbon monoxide, nitrogen dioxide, and fine particulate matter (PM) have been found to trigger episodes in arrhythmia patients. Besides an increase in viral transmission as noted above, other recent studies have shown a correlation between indoor air pollution and carbon dioxide with a decrease in student health and test scores, employee productivity, and even business profits.

Prior to the Covid-19 global pandemic, working from home was already a big trend in the workplace. The devastating novel coronavirus has forced millions of people into an accelerated work-from-home routine. At the same time, there is an emerging post Covid-19 world where people are going back to work and schools have started reopening. In this rapidly changing world, indoor air quality (IAQ) and overall healthy building conditions becomes critical in promoting safety, security, health, well-being, and productivity. By regularly monitoring and tracking indoor air quality and key health performance indicators (HPIs), it is possible to prevent further exposure to indoor pollutants and avoid conditions that allow viruses and bacteria to flourish.

Due to the chronic and worsening nature of the foregoing conditions, many unnecessary medical costs and fatalities can be avoided if indoor environmental quality (the whole indoor healthy environment we live, work and play in), not just air quality, are better managed through improved monitoring, transparency, and public awareness and access. For example, VOC (chemical) pollutants can be up to 10× higher indoors. Indirect costs for missed work and productivity loss in the U.S. due to poor ventilation and sickness are in the hundreds of billions of dollars per year.

There has never been a greater need for the ability to easily monitor, access, share, compare, and promote healthy building metrics for any building from any device, in real time. The system and method of this disclosure resolves these and other problems of the art.

### SUMMARY

In some examples, the system and method of this disclosure is configured to monitor indoor air pollution and healthy environmental conditions provides the tools necessary to easily detect dangerous pollutants and take action to remedy before occupants fall ill and become less productive.

In some examples, the system and method of this disclosure is configured to monitor indoor CO₂ levels inside our homes, offices, classrooms, and retail businesses (concentrations below 1,100 PPM is ideal) and provide access to this information so that high concentrations can be addressed or remedied with proper ventilation and airflow.

In some examples, a user may also scan the system (e.g., a label on the system housing which can include a QR code) whereby the system, upon receipt of a data item caused by system scan and result in the user receiving an output viewable on a display related to indoor air quality and environment conditions before entering an indoor space. In some examples, such conditions can be summarized qualitatively via color codes or in terms of health risk (e.g., mild, medium, moderate, high risk).

In some examples, the indoor environmental quality data can be accessed remotely from any device, easily shared with a link via SMS, email, website or social media post, and easily compared with other “favorite locations” for example, tracking indoor pollution exposure levels from the home, office, gym, restaurant, classroom, and movie theater will allow individuals to monitor, track, share, and compare data from their favorite or most frequented locations and determine the most safe places and which places need improved ventilation and air flow. The system may be able to compare the air quality information from one location to another so that a person can chose which location he or she would like to visit based on air quality. Access to this information may also be used as a marketing tool to promote indoor pollution awareness and to market and advertise healthier living, working, and learning environments which may be used to attract customers, increase business, and generate goodwill with employees, customers, and students.

In some examples, the system and method are configured for utility function and may include a camera, USB ports, back-up battery, emergency LED lights, speaker, and alarm function.

In some examples, the systems and methods of this disclosure are configured for seamless integration with smart systems or intelligent buildings. In some examples, the system can include an open API to provide seamless integration to smart systems which will allow real-time monitoring, corrective measures to be taken in real-time when thresholds are exceeded, and more importantly, to prevent unhealthy conditions from forming. In some examples, data can be fed to the system of this disclosure to communicate with (e.g., control automatically) existing appliances or accessories of a building (e.g., HVAC systems).

In some examples, the systems and methods of this disclosure can include one or more artificial intelligence modules, and more specifically deep learning modules, that can be used to detect one or more environmental levels in locations to identify, detect, and take corrective action with respect to unhealthy patterns or episodes. The systems and methods in this respect increase the accuracy and further allow adaptability to existing conditions. Using artificial intelligence, and more specifically deep learning in these embodiments, may refer to using a deep neural network trained to perform an inference such as detecting or recognizing a particular event or pattern of events, and even predicting future events such as test scores in a classroom, average number of sick days in a given month for students and employees, health related costs, and costs associated with lower business productivity and output due to prolonged indoor pollution exposure.

In some examples, the systems and methods of this disclosure can include instrumentation that monitors one or more environmental factors (e.g., carbon dioxide levels) indicative of possible high concentration of aerosols containing viral pathogens from people exhaling in a room. For example, a classroom or office building with a notification or alert when the parts per million rises above 1,100), or smoke from a fire whereby if a predetermined threshold is exceeded, one or more alarm notifications or alerts can be transmitted electronically and corrective actions taken. The system can include one or more housings with connections similar to existing fire alarm systems. Advantageously, instead of having a fire alarm that only detects carbon dioxide as with conventional approaches, an existing system can be connected to (e.g., hard-wired to, wireless coupled, etc.) to any building structure's system, and also easily integrates wirelessly with any intelligent infrastructure.

In some examples, the system and method of this disclosure is configured for use in web portals as well as social media. For example, the public's insatiable demand for greater transparency and access to critical indoor air pollution metrics, and overall healthy building conditions will only increase in the coming years. In this respect, the system and method of this disclosure can be configured to complement this “know-before-you-go” or “right-to-know” information by publishing environmental air quality information related to a location (e.g., present information monitored or otherwise analyzed by the system in an easily accessible manner through public ratings websites such as YELP ®, Glassdoor ®, or Wikipedia ®). In some examples, the system and method of this disclosure can be used as a marketing tool to validate healthy environmental conditions so as to attract would be clients (e.g., quality tenants and businesses, new employees, and health-conscious customers and students). Data presented can also be used to promote businesses and products on social media platforms such as LinkedIn ®, Facebook®, Instagram®, and Twitter®.

In some examples, the system and method can be used to help drive product and brand awareness and increase business credibility and public trust. Data generated evidencing certain environmental conditions of one or more locations can be used to develop goodwill and highlight corporate and social responsibility issues as businesses, organizations, and schools demonstrate concern for the well-being of their customers, employees, and students. Most importantly, as the system and method of this disclosure to monitor and respond to indoor air pollution threats become more ubiquitous, employee/building occupant health can improve, personal productivity levels will rise, and business profits will follow.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a view of main board dimensions and components distribution according to one example;

FIG. 2 is a view of LTE module dimensions and components distribution according to one example;

FIG. 3 is a block diagram of one device according to one example;

FIG. 4 is a device main board according to one example;

FIG. 5 shows the components on the top side of the board according to one example;

FIG. 6 shows a table summarizing pin distribution according to one example;

FIG. 7 shows components on the top side of the board according to one example;

FIG. 8 shows a table summarizing programming pads according to one example;

FIG. 9 shows an LTE module of an air quality device according to one example;

FIG. 10 shows components of the LTE module shown in FIG. 9 according to one example;

FIG. 11 shows example components in operable connection for an air quality device according to one example;

FIG. 12 shows an example development board voltage level switch according to one example;

FIG. 13 shows an example hardware setup for programming with an example connection diagram according to one example;

FIG. 14A is a view of an example device according to an embodiment of the present disclosure;

FIG. 14B is a view of an example device according to an embodiment of the present disclosure;

FIG. 15 is a view of an example device according to an embodiment of the present disclosure;

FIG. 16 is a view of an example device according to an embodiment of the present disclosure;

FIG. 17 is a view of an example device according to an embodiment of the present disclosure;

FIG. 18 is a view of an example device according to an embodiment of the present disclosure;

FIG. 19 is a view of an example device according to an embodiment of the present disclosure;

FIG. 20 is a view of a container according to an embodiment of the present disclosure;

FIG. 21 is a table showing carbon dioxide levels corresponding with example symptoms associated therewith;

FIG. 22 is a table showing pollutant concentrations at certain predetermined levels;

FIG. 23 is a table by the EPA associated with certain breakpoints;

FIG. 24 is a table showing certain air pollutants, associated causes, and concerns;

FIG. 25 is a table showing certain air pollutants, associated sources, and health effects;

FIG. 26 is a table showing certain air pollutants, associated sources, and health effects;

FIG. 27 is an example graphical user interface for the system of this disclosure;

FIG. 28A is a view of an example device according to an embodiment of the present disclosure; and

FIG. 28B is a view of an example device according to an embodiment of the present disclosure.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Unless defined otherwise, all terms of art, notations and other scientific terms or terminology used herein have the same meaning as is commonly understood by one of ordinary skill in the art to which this disclosure belongs. In some cases, terms with commonly understood meanings are defined herein for clarity and/or for ready reference, and the inclusion of such definitions herein should not necessarily be construed to represent a substantial difference over what is generally understood in the art. All patents, applications, published applications and other publications referred to herein are incorporated by reference in their entirety. If a definition set forth in this section is contrary to or otherwise inconsistent with a definition set forth in the patents, applications, published applications and other publications that are herein incorporated by reference, the definition set forth in this section prevails over the definition that is incorporated herein by reference.

As used herein, “a” or “an” means “at least one” or “one or more.”

As used herein, the term “subject” is not limited to a specific species. For example, the term “subject” may refer to a patient, and frequently a human patient. However, this term is not limited to humans and thus encompasses a variety of mammalian species.

The device is intended for air quality monitoring in indoor environment, through acquiring data from a list of sensors. The device has 2 options—corporate and consumer.

The lists of measuring parameters are the following: AQI (air quality index), mold indication, temperature, humidity, CO₂ (carbon dioxide), NO₂ (nitrogen dioxide), radon, volatile organic compounds (VOC), particulate matter (PM1, PM2.5, PM10), barometric pressure, light intensity (LUX), noise (sound), EMF (electromagnetic radiation), elevation, and location.

A first example of the device may include measurement abilities for the following parameters: humidity, temperature, CO₂ (carbon dioxide), NO₂ (nitrogen dioxide), volatile organic compounds (VOC), particulate matter (PM1, PM2.5, PM10), barometric pressure and may contain a Wi-Fi connection.

A second example of the device may include measurement abilities for the following parameters: humidity, temperature, CO₂ (carbon dioxide), NO₂ (nitrogen dioxide, volatile organic compounds (VOC), particulate matter (PM1, PM2.5, PM10), barometric pressure, light intensity (LUX) and noise (sound) and may contain a Wi-Fi connection.

A third example of the device may include measurement abilities for the following parameters: humidity, temperature, CO₂ (carbon dioxide), NO₂ (nitrogen dioxide), volatile organic compounds (VOC), particulate mattes (PM1, PM2.5, PM10), barometric pressure, light intensity (LUX), noise (sound), device LTE neighbor data, and may contain a Wi-Fi connection, LTE connection, and/or 5G connection.

Sensor data from the assortment of sensors may be received and stored by the system. The system may process the sensor data in real-time, as the data is received using the system-on-a-chip processor and associated memory. Alternatively, the data may be processed at a later time either by the device or a connected server. The system may manipulate the data, filter the data, or map the data produced by the sensors. Common data analysis techniques may be used to change the data into a usable format.

Furthermore, the system may include programs configured to retrieve, store, and/or analyze properties of data models and datasets. For example, system may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The system may include algorithms to determine a data type, key-value pairs, row-column data structure, statistical distributions of information such as keys or values, or other property of a data schema may be configured to return a statistical profile of a dataset (e.g., using a data-profiling model). The system may be configured to implement univariate and multivariate statistical methods. The system may include a regression model, a Bayesian model, a statistical model, a linear discriminant analysis model, or other classification model configured to determine one or more descriptive metrics of a dataset. For example, the system may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The system may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, system may be configured to generate a similarity metric representing a measure of similarity between data in a dataset. A similarity metric may be based on a correlation, covariance matrix, a variance, a frequency of overlapping values, or other measure of statistical similarity.

The system may be configured to generate a similarity metric based on data model output, including data model output representing a property of the data model. For example, system may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The system may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The system may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, system is configured to generate and/or train a classification model to classify a dataset, consistent with disclosed embodiments.

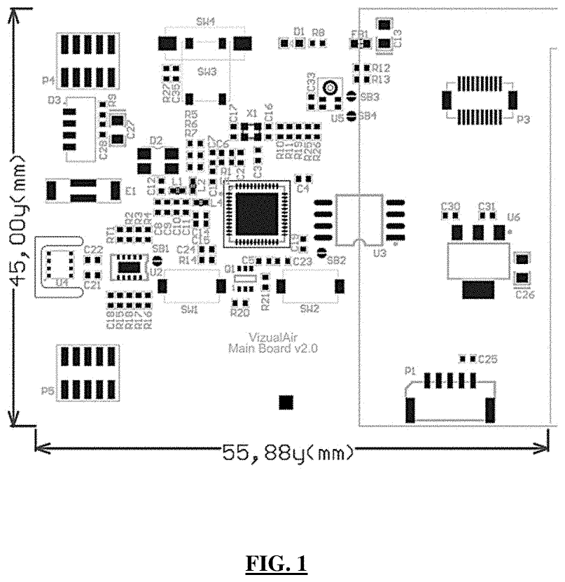

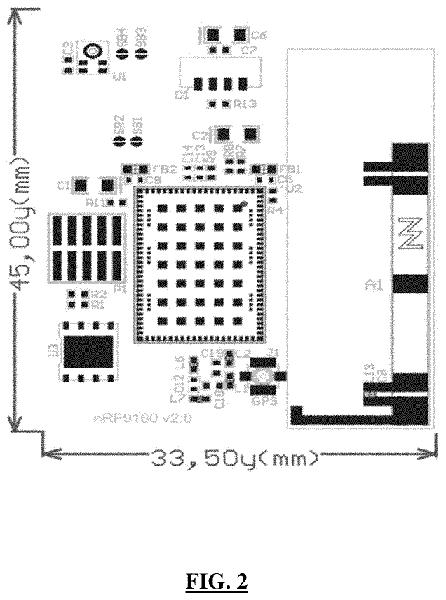

The main board of the device has the following dimensions and components distribution, as shown in FIGS. 1 and 2.

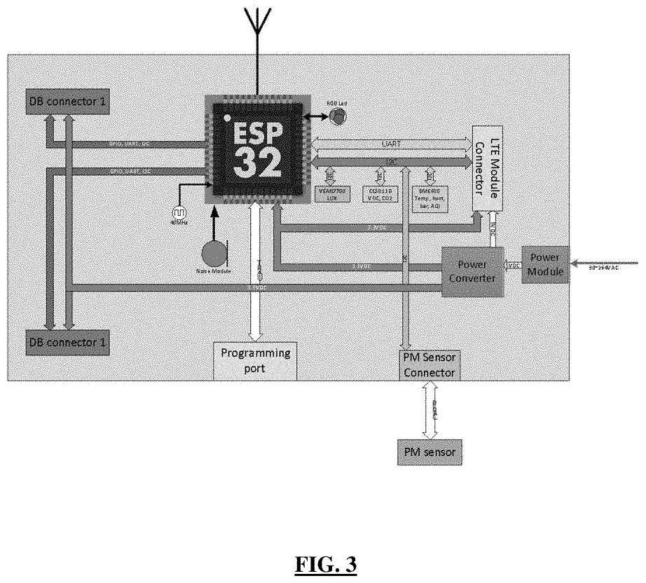

FIG. 3 is a block diagram of one example of the solution of this disclosure. The device may include the following main modules: power converter module, system on a chip (e.g., ESP32), a first air quality monitoring sensor (e.g., BEM680), a second air quality monitoring sensor (e.g., CCS811B), noise measurement module, and lux measurement (e.g., light intensity sensor).

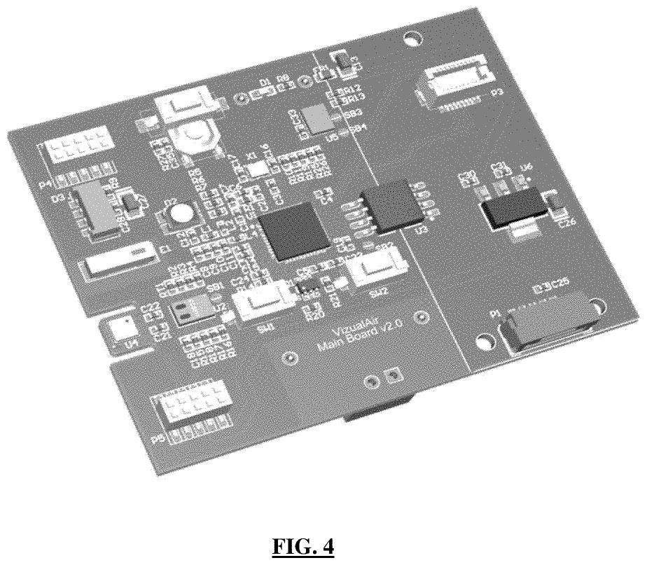

The device main board is shown in FIG. 4.

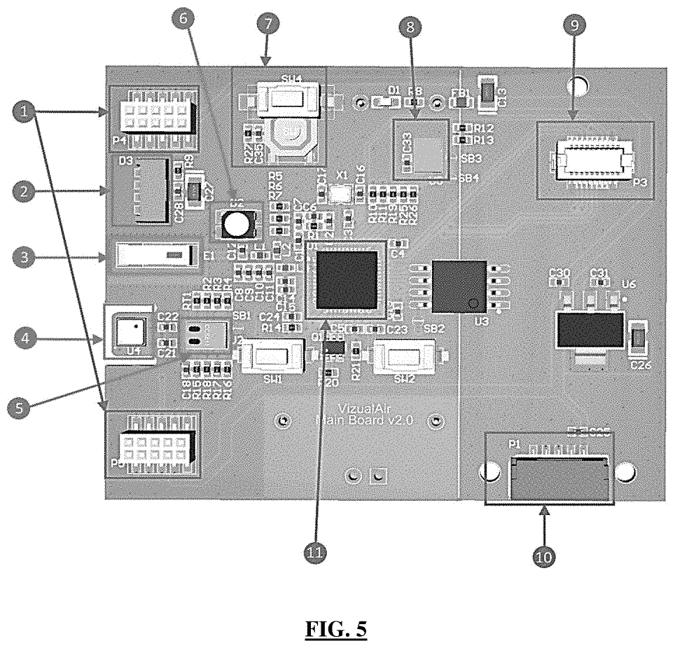

The components on the top side of the board have the following distribution shown in FIG. 5. The annotated elements of FIG. 5 are as follows: daughterboard connectors 5-1, lux (light) sensor 5-2, Wi-fi antenna 5-3, air quality parameters measurement sensor 5-4 (e.g., Bosch BME680 shown), CO₂ air quality monitoring sensor 5-5 (e.g., CCS811B), LED with red-green-blue (RGB) capability 5-6, user button 5-7, microphone 5-8 (noise sensor), LTE module connector 5-9, particle matter (PM) sensor connector 5-10, and transceivers 5-11 (e.g., ESP32 RF transceivers system-on-a-chip (SoC)).

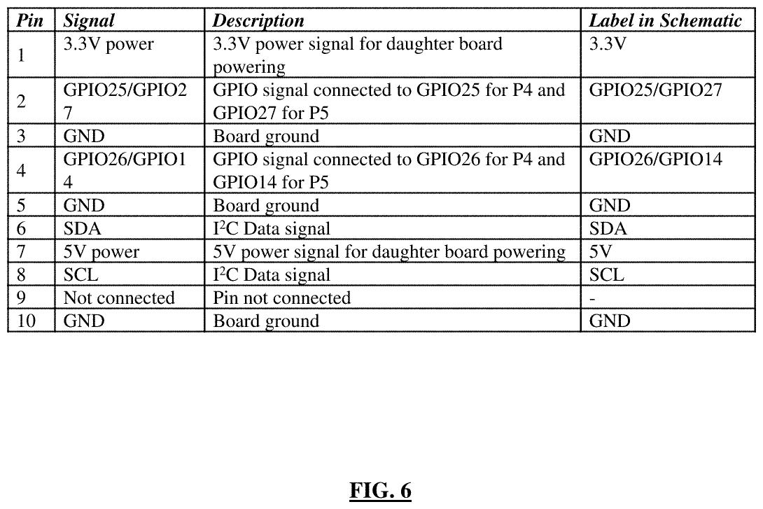

FIG. 6 shows the pins distribution for the daughter board connector.

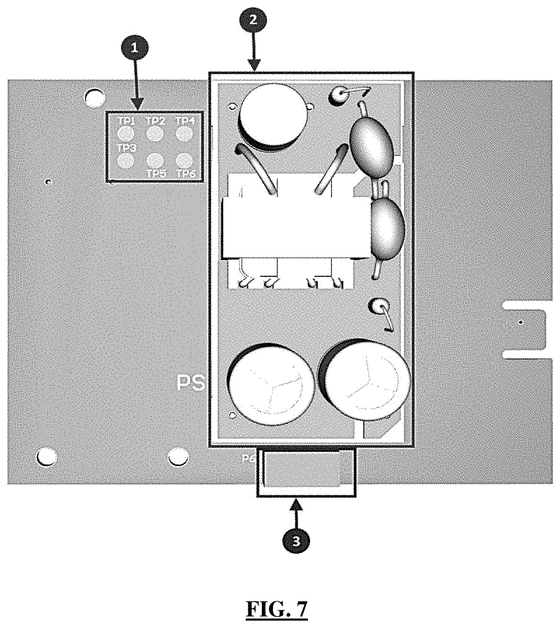

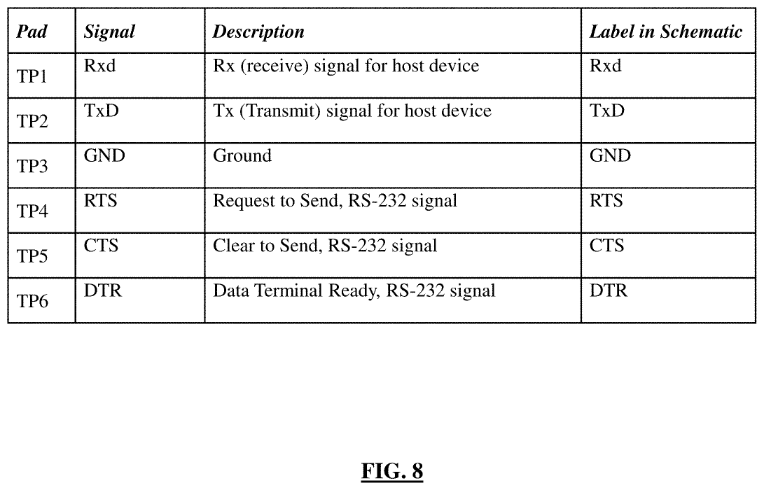

The components on the top side of the board have a distribution according to FIG. 7. Those components include the following: Programming pads 7-1 (FIG. 8 shows pad pinout), AC-DC power supply module 7-2, and 90-264VAC input connector 7-3.

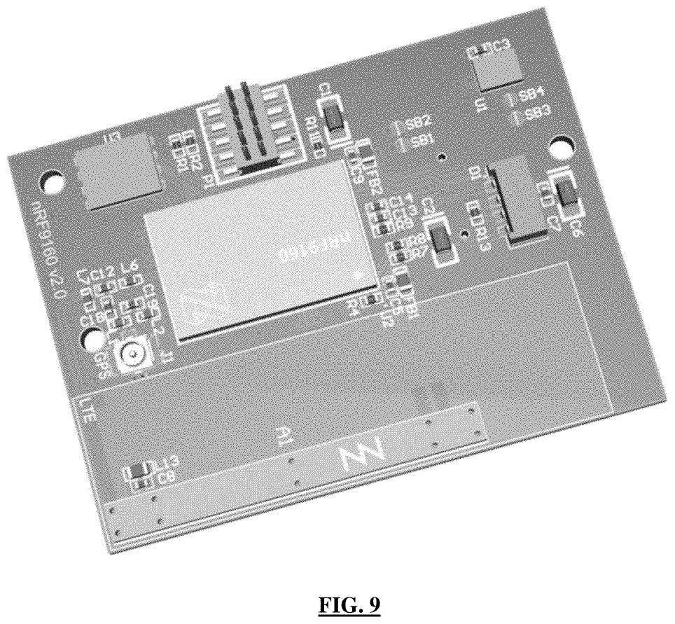

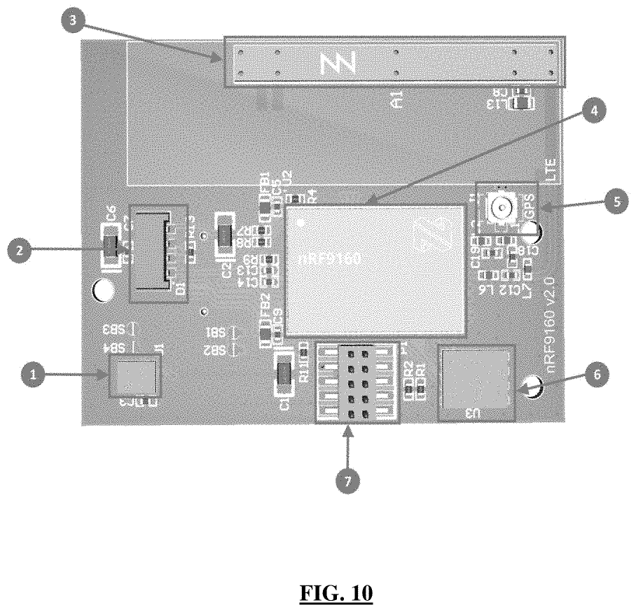

The LTE module of for air quality device is shown in FIG. 9. Components on the LTE module has a distribution shown in FIG. 10. The identified components can include: microphone 10-1 (noise sensor), lux sensor 10-2 (light intensity sensor), LTE antenna 10-3, LTE/GPS module 10-4 (e.g., nRF9160), GPS antenna socket 10-5, eSIM (e.g., hologram eSIM card) 10-6, and LTE module programming connector 10-7.

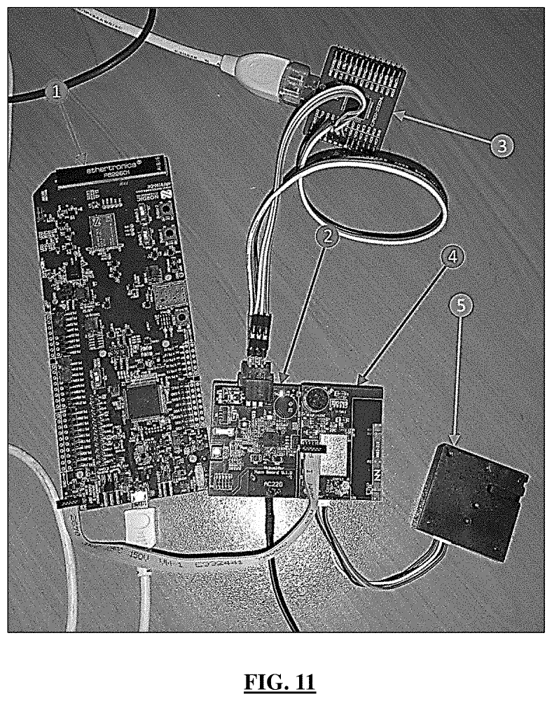

To setup hardware for proper operation, example connections are shown in FIG. 11. These include: programmer for the system on chip on LTE module 11-1, VizualAir main board 11-2, USB (universal serial bus) to UART (universal asynchronous receiver transmitter) converter 11-3 (e.g., FTDI FT2232 chip used for programming ESP32 SoC, VizualAir LTE module 11-4, and dust sensor 11-5 (e.g., Panasonic SN-GCJA5L).

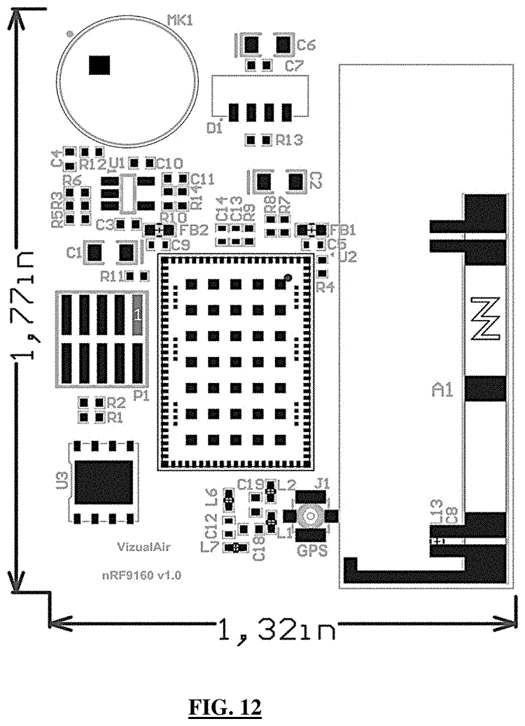

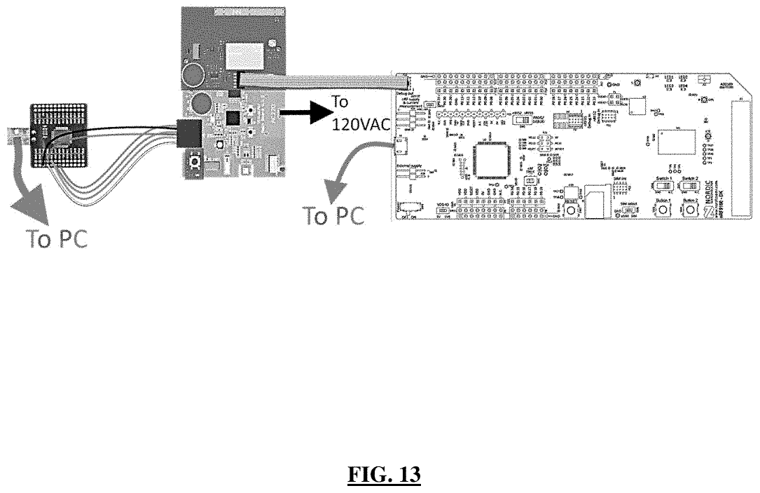

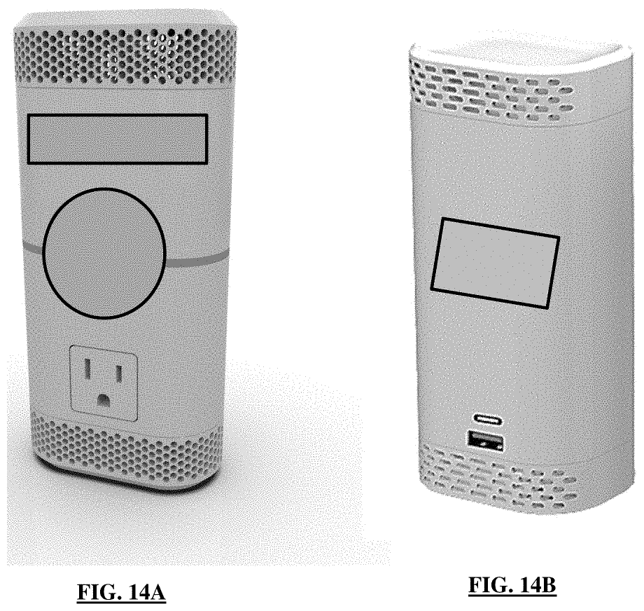

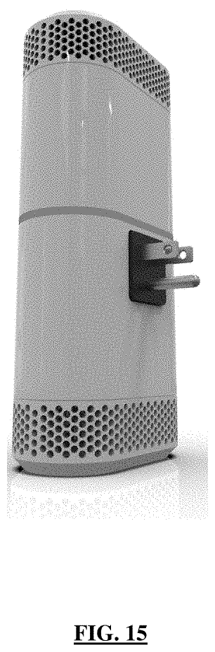

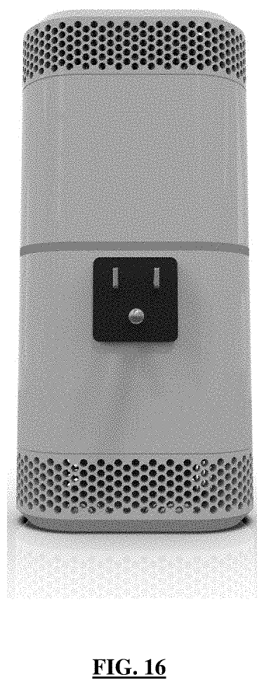

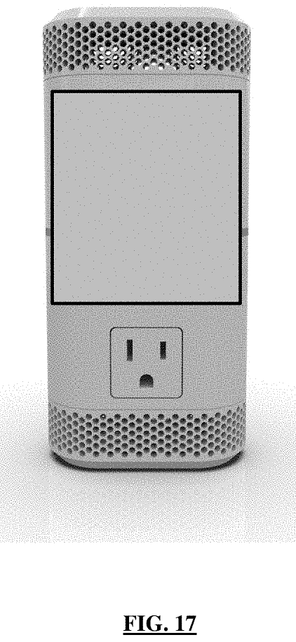

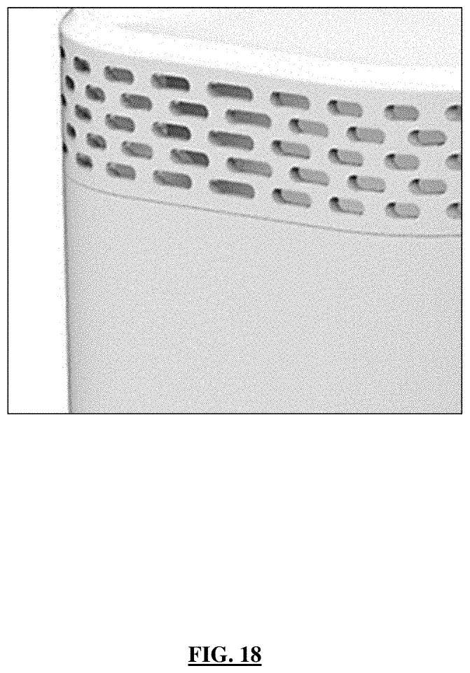

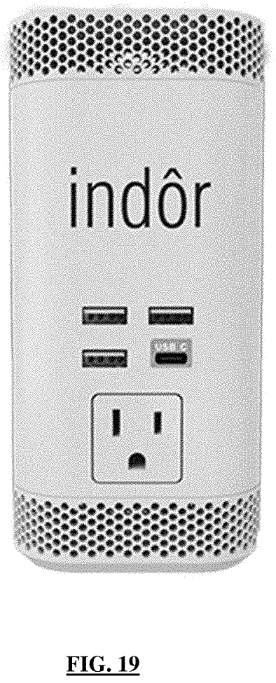

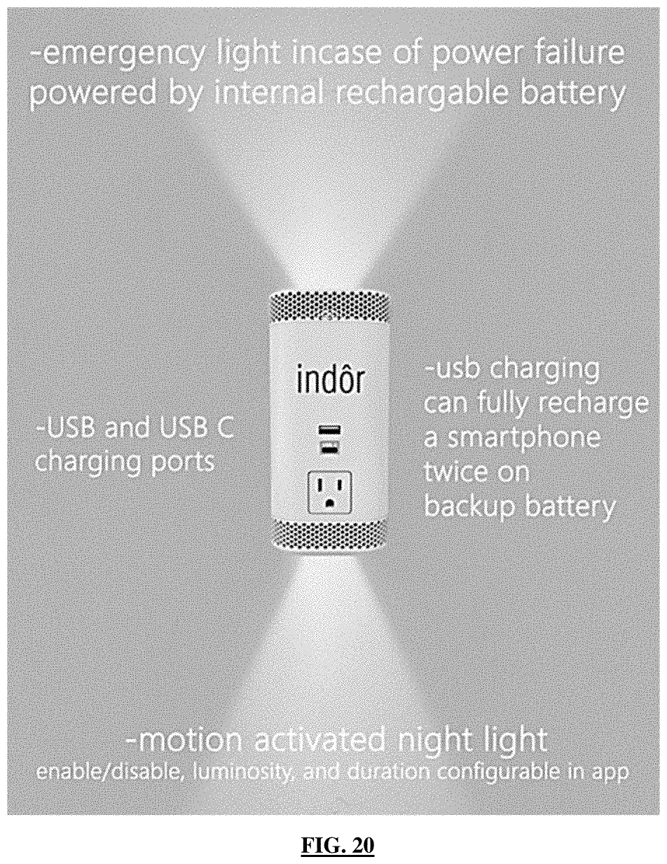

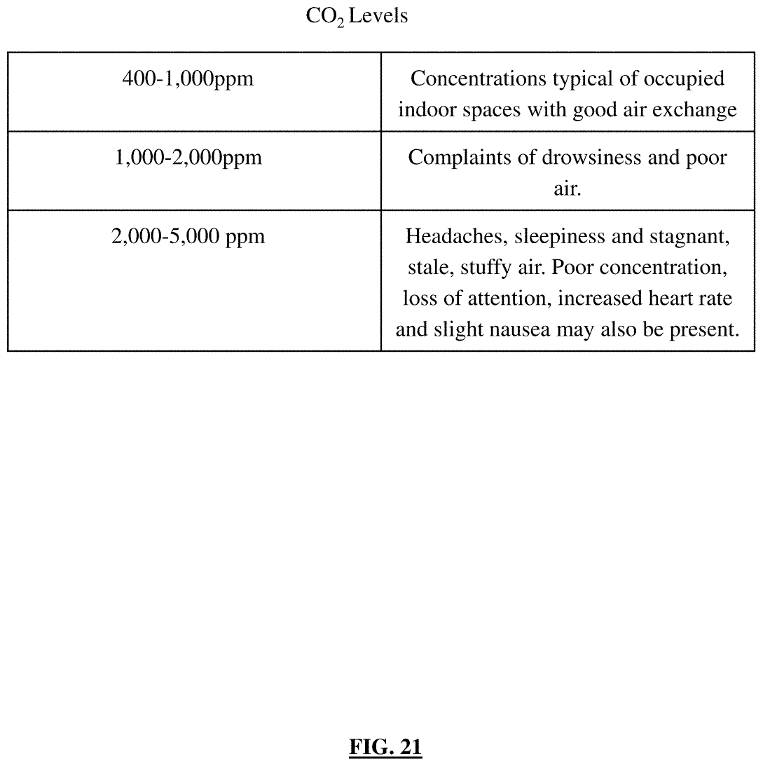

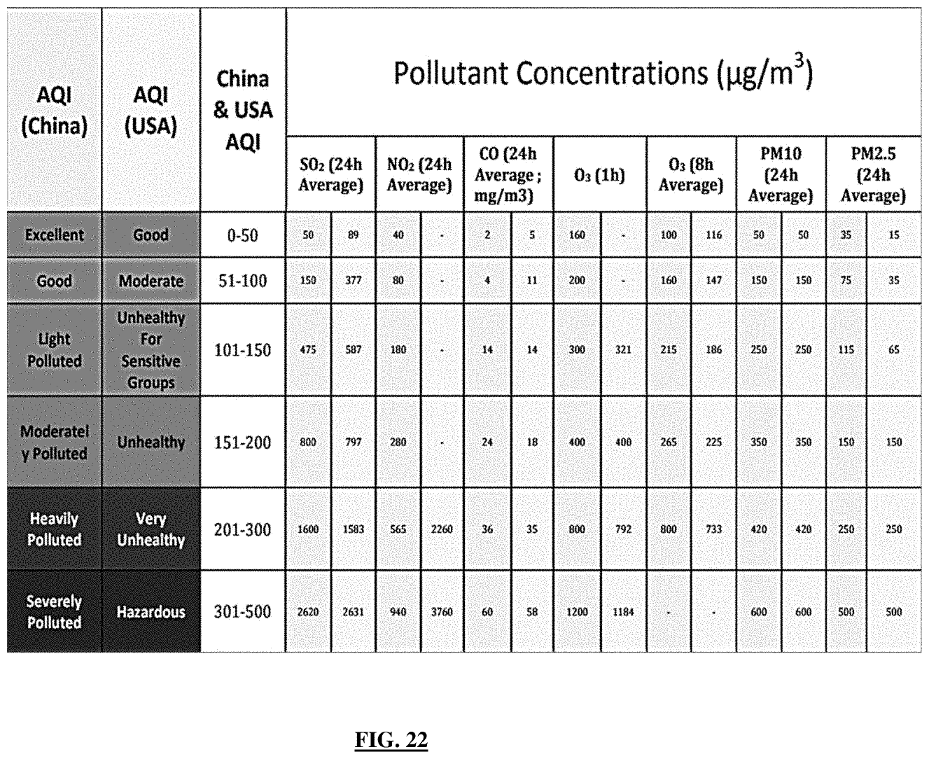

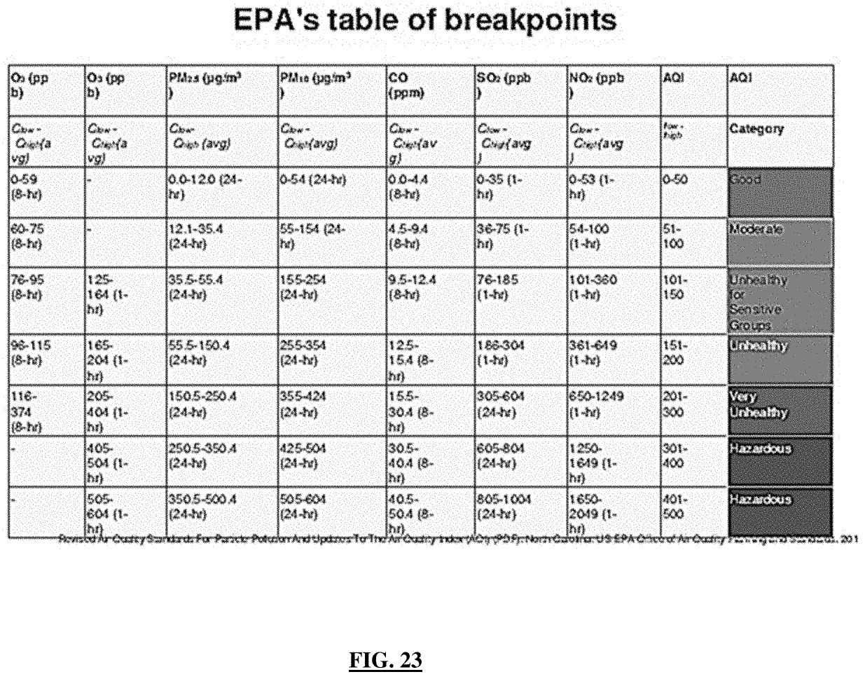

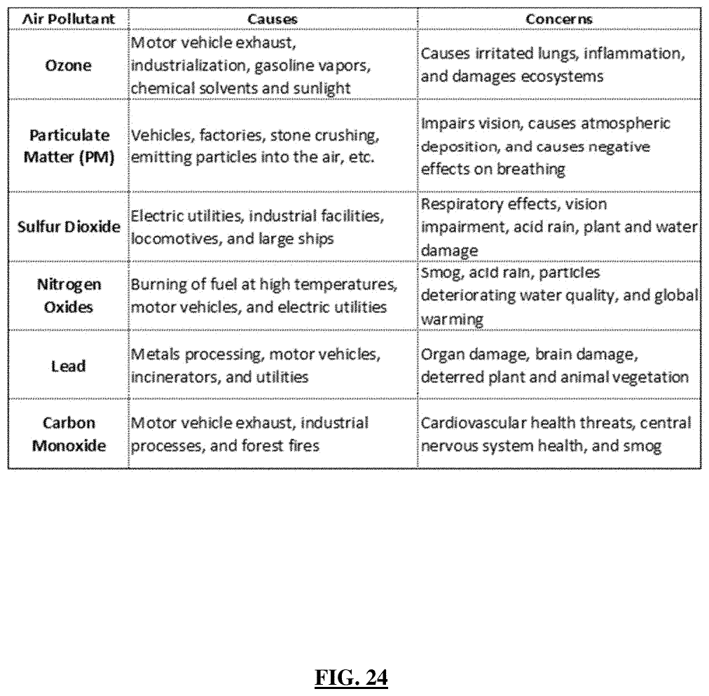

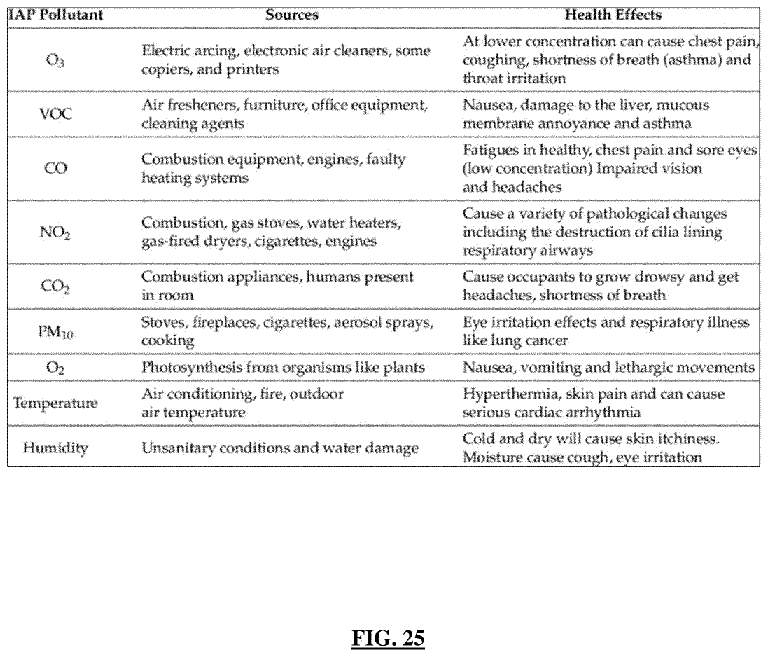

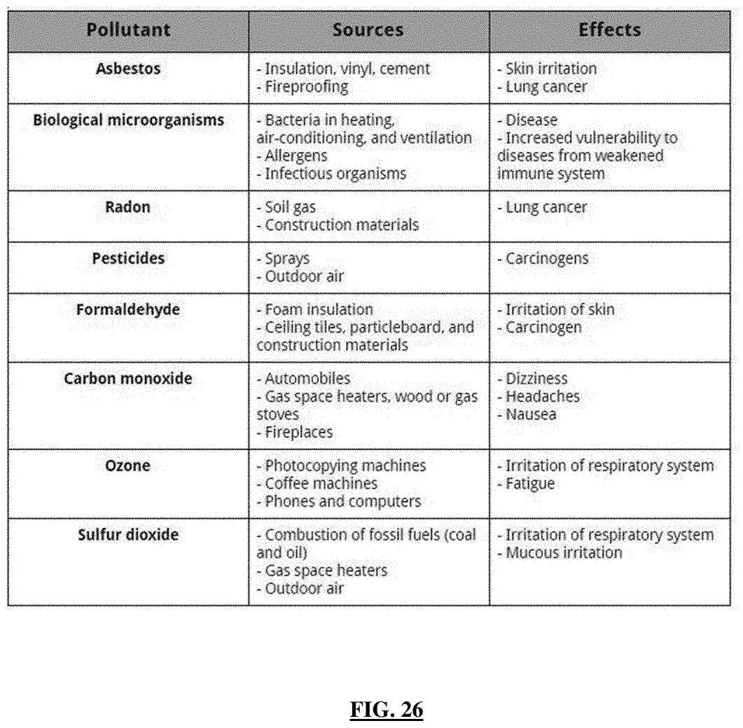

First pin of the connector on the board is highlighted and presented in FIG. 12. Hardware setup for programming has a connection diagram according to FIG. 13. Hardware setup may be completed by connecting the device directly to the USB port of a PC through a micro-USB cable.

Systems and methods of this disclosure can include cutting edge sensor modules that measure indoor pollutions levels and overall IEQ. In some examples, no network connectivity, local or otherwise, may be required. Instead, narrowband IoT of the system can ensure simple, secure, remote access. In some examples, the system can be configured to accumulate data from which health and business productivity trends can be predicted.

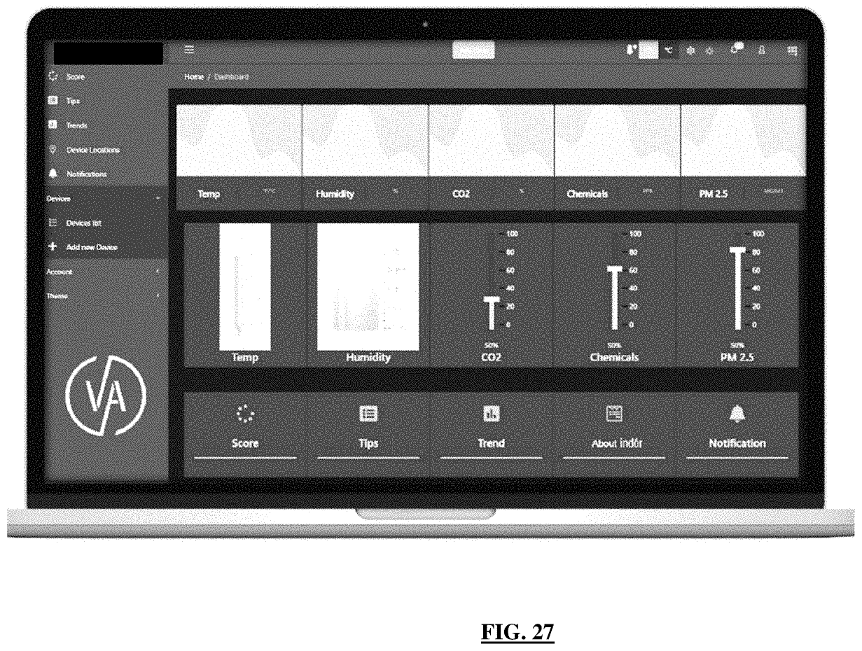

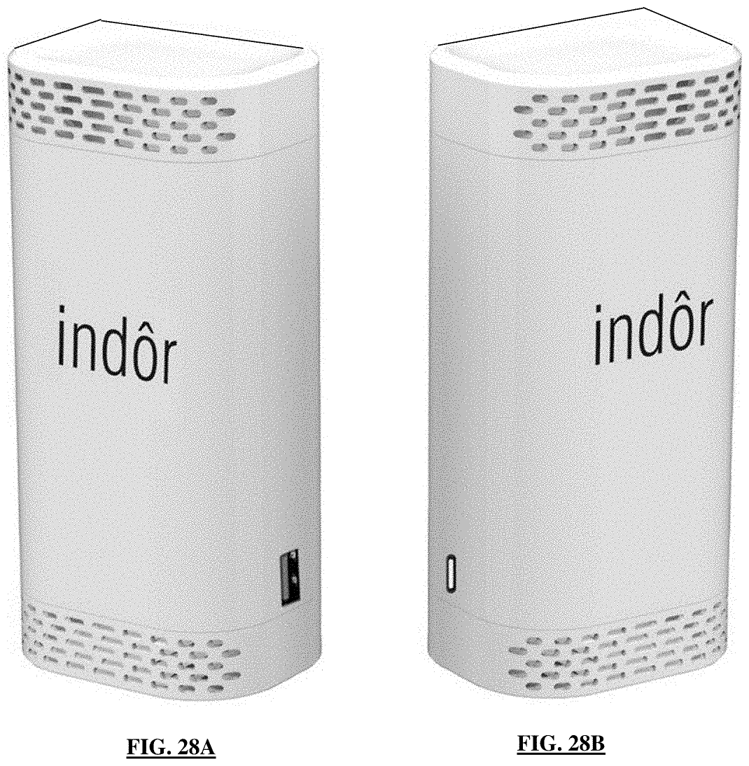

FIG. 27 is an example graphical user interface for the system of this disclosure. As can be seen, the interface monitors temperature, humidity, carbon dioxide, one or more chemicals, particle matter 2.5, among other potential metrics. A user can also view scores indicative of current or predictive metrics related to environmental information. The graphical user interface may be accessed from a user's mobile device (e.g., cellular telephone, laptop, personal digital assistant) using a hyperlink, QR code, or mobile application. The hyperlink may be sharable between devices. The QR code may operate such that a user can aim the camera of their mobile device at the QR code. The mobile device camera may then take a picture of the code. Using image processing, the mobile device may recognize text, a hyperlink, or other information from the QR code. This may then cause the mobile device to open a webpage associated with (or hosted by) the system. The system may transmit the graphical user interface to the user device using Wi-Fi or an LTE or 5G chip connected to a cellular network.

The graphical user interface of the system (shown in FIG. 27) may update readings from the sensors in the system automatically. This allows the user to have a live readout of all the metrics provided by the system that updates automatically as the system receives more information from the assorted sensors. The user may be able to interact with the graphical user interface to select and view current and past data for individual metrics. The user may also be able to see forecasts of future anticipated metric levels (via the “Trend” option shown on FIG. 27), which may be created by one or more artificial intelligence modules.

The system may include programs (scripts, functions, algorithms) to configure data for visualizations on the graphical user interface and provide visualizations of datasets and data models on the user device. This may include programs to generate graphs and display graphs. The system may include programs to generate histograms, scatter plots, time series, or the like on the user device. The system may also be configured to display properties of data models and data model training results including, for example, architecture, loss functions, cross entropy, activation function values, embedding layer structure and/or outputs, convolution results, node outputs, or the like on the user device.

The graphical user interface may also compare metrics and air quality indicators with other systems in other locations. This is able to help the user choose where they may want to go based on how clean the air is (e.g., user sees that a first restaurant has polluted or unclean air using the graphical user interface and compares that with a second restaurant with that the system shows to have cleaner air. The user then decides to go to the second restaurant based on the cleaner air metric). The graphical user interface may show other nearby locations of devices on a map and may also show outdoor weather conditions in the surrounding area.

The graphical user interface may also provide a notification option. The notification option may alert users or may feature an alarm that warns users when air quality metrics are outside a safe range (e.g., the alarm may emit a sound on the user's mobile device or display a visual warning, for example, different color text, or bold text telling the user that an unsafe condition exists). This alarm may be emitted by the unit itself in addition to the graphical user interface.

The graphical user interface may also provide a score that summarizes the air quality of a location using information taken from the numerous metrics. The summary may feature a color code system that tracks health risks based on the air quality (e.g., green representing clean air with a low or normal health risk, yellow representing air with moderate health risk, red representing a high health risk). The system may compare the health risk to measurements from other locations in the area.

The graphical user interface may be shared through link or email. Users may be able to setup a user account and be able to track the air quality of their favorite locations. Users may be able to share the air quality of certain location with other users and non-users using hyperlinks, SMS text messaging, instant messaging, email, and other methods commonly known in the art.

Systems and methods of this disclosure improve environmental monitoring so as to, for example, increase ventilation and thus ensure that persons in the environment monitored maintain cognitive ability, productivity, and business profits. Systems and methods of this disclosure can also deliver transparency and improved access to healthy building conditions for the masses, satisfy high-growth demand, further boost employee and consumer confidence post COVID-19, leverage the IoT platform to continuously monitor unhealthy indoor environments, and precisely and efficiently respond to the factors that keep the building and its occupants healthy and productive.

While indoor air conditions are described throughout this disclosure, such conditions are not limited to static buildings or structures. Rather, the systems and methods of this disclosure are configured for use within spaces of vehicles (e.g., planes, automobiles, trains, buses, submarines, boats, helicopters, etc.). In some embodiments, the systems and methods of this disclosure is configured for use with an onboard computer or comfort system of a corresponding vehicle to alert and create awareness of conditions that meet or exceed predetermined conditions associated with healthy environments for end-users or other passengers. The systems and methods are also configured to perform corrective measures (e.g., if a predetermined threshold is met or exceeded, a corrective action can be prompted by the system) to be autonomously taken so no action is required.

In some examples, the systems and methods of this disclosure can include instrumentation that monitors one or more environmental factors (e.g., carbon dioxide levels) indicative of possible high concentration of aerosols containing viral pathogens from people exhaling in a room. For example, a classroom or office building with a notification or alert when the parts per million rises above 1,100), or smoke from a fire whereby if a predetermined threshold is exceeded, one or more alarm notifications or alerts can be transmitted electronically and corrective actions taken. The system can include one or more housings with connections similar to existing fire alarm systems. Advantageously, instead of having a fire alarm that only detects carbon dioxide as with conventional approaches, an existing system can be connected to (e.g., hard-wired to, wireless coupled, etc.) to any building structure's system, and also easily integrates wirelessly with any intelligent infrastructure.

In some examples, a user may also scan the system (e.g., a label on the system housing which can include a QR code) whereby the system, upon receipt of a data item caused by system scan and result in the user receiving an output viewable on a display related to indoor air quality and environment conditions before entering an indoor space. In some examples, such conditions can be summarized qualitatively via color codes or in terms of health risk (e.g., mild, medium, moderate, high risk).

In some examples, this indoor environmental quality data can be accessed remotely from any device, easily shared with a link via SMS, email, website or social media post, and easily compared with other “favorite locations”. For example, the system and method can be used for tracking indoor pollution exposure levels from the home, office, gym, restaurant, classroom, and movie theater will allow individuals to monitor, track, share, and compare data from their favorite or most frequented locations and determine the safest places and which places need improved ventilation and air flow. Access to this information may also be used as a marketing tool to promote indoor pollution awareness and to market and advertise healthier living, working, and learning environments which may be used to attract customers, increase business, and generate goodwill with employees, customers, and students.

In some examples, the system may include use of a server to store and track sensor data and other information. The server may be used in conjunction with the measuring device to aid users in contacting the measuring device when scanning the QR code. The server may also allow the user to locate a device and view metric data without scanning a QR code.

In some examples, the system and method are configured for utility function and may include a camera, USB ports, back-up battery, emergency LED lights, speaker, and alarm function. The LED lights and speaker may be configured to light up and sound when the alarm is activated. The back-up battery may be able to serve as a power source and charge user devices via the USB ports in the event of a power failure. The system may also include a standard US power plug. The system may be configured to turn on LED lights automatically in the event of a power failure. The LED lights may also be configured to be a motion-activated night light by using the light sensor to detect movement.

The alarm may have a variety of features. Specifically, the alarm may be configured to create a sound using the speaker or create flashes of light using the LED lights if an air quality problem exists. The alarm may also create specific patterns of flashes or specific sounds indicating specific air quality issues (e.g., two beeps for carbon dioxide warning and three beeps for particulate matter warning). The alarms may be repeated until turned off or turn off after a set amount of time or if the condition no longer exists. The volume emitted by the speaker may change based on the severity of the alarm (e.g., more dangerous condition is louder).

In some examples, the systems and methods of this disclosure are configured for seamless integration with smart systems or intelligent buildings. The system may include interface software and hardware for aiding such integration. In some examples, the system can include an open application programming interface (API) to provide seamless integration to smart systems which will allow real-time monitoring, corrective measures to be taken in real-time when air quality moves outside predetermined thresholds, and more importantly, to prevent unhealthy conditions from forming. In some examples, data can be fed to the system of this disclosure to communicate with (e.g., control automatically) existing appliances or accessories of a building (e.g., HVAC systems). For example, the system may monitor humidity levels within a building. When the humidity levels go outside a predetermined threshold (either above or below a certain range) or the system's deep learning model anticipates the humidity will exceed a threshold in a short amount of time the system may send a signal to the HVAC in the building via the API to tell the HVAC to turn on the air conditioning to reduce the humidity, to, for example, prevent the growth of mold. Similarly, in another example, in buildings equipped with an outdoor air intake for the HVAC, if the air quality monitoring system detects excess carbon dioxide building up inside the building, the system can send a signal to the HVAC to open the outdoor air intake and turn on the fan to circulate fresh air. The system may be able to interact with, for example, HVAC systems, fire alarms, carbon dioxide and carbon monoxide sensors, sprinkler systems, automatic door systems, among others.

In some examples, the systems and methods of this disclosure can include one or more artificial intelligence modules, including machine learning models, and more specifically deep learning modules, that can be used to detect one or more environmental levels in locations to identify, detect, and take corrective action with respect to unhealthy patterns or episodes. The systems and methods in this respect increase the accuracy and further allow adaptability to existing conditions. Using artificial intelligence, including machine learning models, and more specifically deep learning in these embodiments, may refer to using a deep neural network trained to perform an inference such as detecting or recognizing a particular event or pattern of events, and even predicting future events such as test scores in a classroom, average number of sick days in a given month for students and employees, health related costs, and costs associated with lower business productivity and output due to prolonged indoor pollution exposure.

The system may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The system may be configured to adjust model parameters during training Model parameters may include weights, coefficients, offsets, or the like. Training may be supervised or unsupervised.

The system may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The system may be configured to optimize statistical models using known optimization techniques.

The system may consider the sensor data based on predetermined thresholds. The predetermined thresholds may be set by the deep learning model or may include preset thresholds. Acceptable values for sensor data may be a range. The predetermined thresholds may be a set value above or below the range or a percentage. The predetermined thresholds may vary based on location, time of year, and other factors. If a sensor value goes outside the predetermined threshold, an alarm may be triggered, or a notice to the user may be presented. There may be multiple sets of predetermined thresholds for a sensor. For example, the first predetermined threshold may include a notice to a user that a certain sensor value is elevated. A second predetermined threshold may include a warning that the air quality is potentially toxic. A third predetermined threshold may sound an alarm and instruct the user to leave the area because the air quality is toxic. The predetermined thresholds may be dependent on other sensor data (e.g., carbon dioxide can be between value X and value Y if the temperature is below value Z, but if the temperature is above value Z, the carbon dioxide can be between value A and value B). The predetermined thresholds may also be anticipatory based on the deep learning model.

The system may also contain one or more prediction models to predict future air quality issues based on prior trends. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models. Prediction models may additionally or alternatively include classification and regression trees, or other types of models known to those skilled in the art. To generate prediction models, the system may analyze information applying machine learning methods.

The system may also incorporate confidence levels into monitoring the sensor data. The confidence levels may be based on prior data provided to the deep learning model. The confidence level may influence the values of the predetermined thresholds.

Other features and advantages of the systems and methods of this disclosure will be apparent from the description herein. The examples are provided herein are solely to illustrate the vest by reference to specific embodiments. These exemplifications, while illustrating certain specific aspects of the system and methods, do not portray the limitations or circumscribe the scope of the disclosed invention. Many variations to those described above are possible.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art.

Such other examples are intended to be within the scope of the claims if they have structural elements that do not differ from the literal language of the claims, or if they include equivalent structural elements with insubstantial differences from the literal language of the claims.

What is claimed is:

1. An air quality monitoring system comprising:
one or more air quality monitoring sensors;
one or more transceivers;
one or more processors;
memory in communication with the one or more processors and storing instructions that, when executed, are configured to cause the system to:
receive air quality metric data from the one or more air quality monitoring sensors;
detect, using a deep learning neural network, current environmental conditions from the air quality metric data; and
transmit the current environmental conditions to a user device.

2. The air quality monitoring system of claim 1, wherein the one or more air quality monitoring sensors further comprises a first sensor for measuring carbon dioxide levels in air and a second sensor for measuring particle matter levels in the air.

3. The air quality monitoring system of claim 1, wherein the air quality metric data comprises one or more metrics of humidity, temperature, carbon dioxide, nitrogen dioxide, volatile organic compounds, particular matter, and barometric pressure or combinations thereof.

4. The air quality monitoring system of claim 1, wherein the instructions, when executed, are further configured to cause the system to:
retrieve prior environmental conditions;
identify, using the deep learning neural network, an adverse environmental pattern based on the prior environmental conditions and the current environmental conditions; and
transmit, to the user device, a notification indicative of the adverse environmental pattern.

5. The air quality monitoring system of claim 4, wherein identifying the adverse environmental pattern further comprises determining that one or more metrics of the air quality metric data falls outside a predetermined range.

6. The air quality monitoring system of claim 1, further comprising:
a light sensor configured to measure light intensity; and
a microphone.

7. The air quality monitoring system of claim 1, wherein the instructions, when executed, are further configured to cause the system to:
determine that a predetermined amount of time has passed; and
store the current environmental conditions as prior environmental conditions.

8. The air quality monitoring system of claim 1, wherein transmitting the current environmental conditions to the user device further comprises:
summarizing the current environmental conditions;
determining a health risk based on the current environmental conditions;
generating a color code based on the health risk; and
sending the color code and health risk to the user device.

9. The air quality monitoring system of claim 1, further comprising:
one or more lights; and
a speaker.

10. The air quality monitoring system of claim 9, wherein the instructions, when executed, are further configured to cause the system to:
determine, from the current environmental conditions, that an emergency condition exists; and
output an alarm function using the one or more lights and the speaker.

11. The air quality monitoring system of claim 1, wherein the one or more transceivers is configured to connect to a WiFi or LTE network.

12. The air quality monitoring system of claim 1, wherein the system is configured to interact with one or more in-building fire alarms and with one or more air conditioning control units.

13. An air quality monitoring system comprising:
one or more air quality monitoring sensors;
one or more transceivers;
one or more processors;
memory in communication with the one or more processors and storing instructions that, when executed, are configured to cause the system to:
receive air quality metric data from the one or more air quality monitoring sensors;
detect, using a deep learning neural network, current environmental conditions from the air quality metric data;
receive, from a mobile device of a user, a request for the current environmental conditions; and
transmit, the current environmental conditions to the mobile device of the user.

14. The air quality monitoring system of claim 13 further comprising a scannable QR code, wherein the mobile device of the user generates the request by scanning the QR code.

15. The air quality monitoring system of claim 13 further comprising a scannable QR code, wherein the QR code contains a URL associated with the air quality monitoring system.

16. The air quality monitoring system of claim 13, wherein the instructions, when executed, are further configured to cause the system to share the current environmental conditions on one or more social media and public ratings websites.

17. The air quality monitoring system of claim 13, wherein the instructions, when executed, are further configured to cause the system to:
identify, from the current environmental conditions, an emergency condition; and
transmit an alarm message to the mobile device of the user, the alarm message being configured to trigger an alarm on the mobile device of the user.

18. An air quality monitoring system comprising:
a plurality of air quality monitoring sensors comprising a first air quality monitoring sensor and a second air quality monitoring sensor;
one or more processors;
memory in communication with the one or more processors and storing instructions that are configured to cause the system to:
receive first air quality metric data from the first air quality monitoring sensor in a first location;
receive second air quality metric data from the second air quality monitoring sensor in a second location;
detect, using a deep learning neural network, current environmental conditions from the first air quality metric data and the second air quality metric data;
track the current environmental conditions for the first location and second location;
compare the current environmental conditions for the first location with the current environmental conditions for the second location; and
generate a comparison message based on the comparison.

19. The air quality monitoring system of claim 18, wherein the instructions, when executed, are further configured to cause the system to:
receive, from a third-party mobile device, a request for the comparison message; and
transmit, to the third-party mobile device, the comparison message.

20. The air quality monitoring system of claim 18, wherein the instructions, when executed, are further configured to cause the system to share the comparison message on one or more social media and public ratings websites.
